(19) United States
(12) Patent Application Publication
(10) Pub. No.: US 2023/0372073 A1
(43) Pub. Date: Nov. 23, 2023

(54) ORAL CARE KITS, APPARATUS AND METHODS

(71) Applicant: AIRWAY MEDIX S.A., Warszawa (PL)

(72) Inventor: Oron ZACHAR, Tel Aviv (IL)

(21) Appl. No.: 18/248,126

(22) PCT Filed: Oct. 8, 2020
(86) PCT No.: PCT/IB2020/059475

§ 371 Date: Apr. 6, 2023

(51) Int. Cl. A61C 17/08; A61C 17/22; A46B 9/04

(52) U.S. Cl. CPC A61C 17/08; A61C 17/227; A46B 9/04

(57) ABSTRACT

An oral care kit comprises (i) a compressible pipette including a fluid-storage compartment and a fluid-loading tube, and (ii) a suction toothbrush having an attachment element externally disposed on a lateral-facing surface of the suction toothbrush. The attachment element is configured to stably and detachably retain the compressible pipette in a fixed orientation external to the suction toothbrush.

### CROSS-REFERENCE TO RELATED APPLICATIONS

This patent application claims the benefit of U.S. Provisional Patent Application No. 62/912,093 filed on Oct. 8, 2019, and of U.S. Provisional Patent Application No. 62/932,522 filed on Nov. 8, 2019, both of which are incorporated herein by reference in their entirety.

### FIELD OF THE INVENTION

The present invention relates to oral care kits based on a suction toothbrush, and particularly to kits appropriate for institutional oral-care use.

### SUMMARY

According to embodiments, an oral care kit comprises: (a) a compressible pipette (e.g. elongated pipette) having a fluid-storage compartment (e.g. defining a set of equilibrium dimensions), the pipette having a fluid-loading tube extending from the fluid-storage compartment (e.g. at one end thereof), wall(s) of the fluid-storage compartment being deformable so that when the fluid-storage compartment is at least partly compressed, at least partial decompression of the fluid-compartment by a restorative force produces a negative pressure which loads the fluid storage compartment via the fluid-loading tube (e.g. when a tip of the fluid-loading tube is immersed in fluid); and (b) a suction toothbrush having an attachment element that is (i) externally disposed on a lateral-facing surface of the suction toothbrush; and (ii) configured to stably and detachably retain the compressible pipette in a fixed orientation external to the suction toothbrush, the suction toothbrush comprising (i) a suction-lumen outlet at a proximal end, and (ii) a dentrifice-delivery lumen having an dentrifice-delivery outlet within or in proximity to a distally-disposed field of toothbrush bristles, and an inlet displaced proximally therefrom.

In embodiments of the invention when the compressible pipette is stably retained by the attachment element in the fixed orientation external to the suction toothbrush, at least one or at least two or at least three of the following conditions are satisfied: (CONDITION A) at least one external surface of the fluid-storage compartment is exposed and accessible to direct access; (CONDITION B) a distal end of the fluid-loading tube forms a fluid-tight seal with a proximal end of the dentrifice-delivery lumen to complete a dentrifice flowpath from an interior of the fluid-storage compartment to the dentrifice-delivery outlet; and/or (CONDITION C) a force directly applied (e.g. applied laterally towards the suction toothbrush) upon the exposed and directly accessible external surface of the deformable wall of the fluid-storage compartment at least partially compresses the fluid-storage compartment to expel therefrom dentrifice stored therein so that the expelled dentrifice follows the dentrifice flowpath and exits the dentrifice-delivery lumen (e.g. as a jet of fluid) via the dentrifice-delivery outlet.

In this manner, the fluid-loading tube is multi-functional is may be used both (i) for loading—e.g. to load the fluid-storage compartment (e.g. by the negative pressure) in to the fluid-storage compartment and (ii) for expelling therefrom (e.g. so the fluid exits the dentrifice-delivery outlet(s)) (e.g. to delivering into the mouth).

In some embodiments, multiple walls of the fluid-storage compartment can be deformable.

In some embodiments, the fluid-storage compartment can have only a single aperture, at a proximal end of the fluid-loading tube. In some embodiments, the compressible pipette can have only a single aperture, at a distal end of the fluid-loading tube. E.g. sealing only the fluid-loading tube is sufficient to seal the entire fluid-storage compartment

In some embodiments, a hardness of the fluid-loading tube exceeds a hardness of walls of the fluid delivery compartment. Alternatively or additionally, a wall-thickness of walls of the fluid-loading tube exceeds a wall-thickness of walls of the fluid delivery compartment.

In some embodiments, a ratio between (i) a wall-thickness of walls of the fluid-loading tube and (ii) a wall-thickness of walls of the fluid delivery compartment is at least 2.

In some embodiments, a ratio between (i) a wall-thickness of walls of the fluid-loading tube and (ii) a wall-thickness of walls of the fluid delivery compartment is at least 3.

In some embodiments, a ratio between (i) a wall-thickness of walls of the fluid-loading tube and (ii) a wall-thickness of walls of the fluid delivery compartment is at least 5.

In some embodiments, no valve is disposed along (e.g. within) in fluid-loading tube. Alternatively or additionally, no valve is disposed along (e.g. within) the dentrifice flowpath between an interior of the fluid-storage compartment and the dentrifice-delivery outlet.

In some embodiments, a length of the fluid-loading tube is at least 20% of a longest dimension of the fluid-storage compartment.

In some embodiments, a length of the fluid-loading tube is at least 30% of a longest dimension of the fluid-storage compartment.

In some embodiments, it can be that (i) the fluid-storage compartment is elongated to define an elongate axis, (ii) when the pipette is detached from the suction toothbrush, the fluid-loading tube is aligned with the elongate axis of the fluid-storage compartment, and/or (iii) when the compressible pipette is stably retained by the attachment element in the fixed orientation external to the suction toothbrush, the fluid-loading tube is laterally bent toward an external surface of the suction toothbrush to complete the dentrifice flowpath.

In embodiments of the invention, an outer radius of the fluid-loading tube (e.g. at a distal tip thereof) matches (e.g. is slightly less than) an inner radius of the dentrifice-delivery lumen at a proximal end thereof—e.g. so that a tip of the fluid-loading tube may penetrate into the dentrifice-delivery lumen where the radii match sufficiently so that a liquid-tight seal is formed by the penetration.

In some embodiments, the compressible pipette can be laterally compressible. In some embodiments, the compressible pipette can include a bellows at a proximal end and/or be longitudinally compressible.

In some embodiments, it can be that the inlet of the dentrifice-delivery lumen faces proximally, and/or, in the assembled state, the outlet pipe of the pipette is distally oriented.

In some embodiments, the oral care kit can additionally comprise a bendable suction member.

In some embodiments, the attachment element can comprise a snap-in cradle. In some embodiments, the attachment element can comprise a ring or a ring segment.

In some embodiments, it can be that when in the assembled state, at least a deformable portion of an outer surface of the pipette is uncovered and open to direct external contact. In some embodiments, it can be that when in an assembled state, at least a distal tip of the fluid-loading tube of the compressible pipette is disposed within the inlet of the dentrifice-delivery lumen so as to (i) form a liquid-tight seal therebetween and/or (ii) complete a dentrifice-flowpath from the compressible pipette to the outlet of the dentrifice-delivery lumen. Thus, in some embodiments, to form the liquid-tight seal a distal end of the fluid-loading tube penetrates (e.g. by at least 1 mm) (e.g. by at least 2 mm) into a proximal end of the dentrifice-delivery lumen.

In some embodiments, a packaging unit can comprise a kit according to any one of the embodiments in the preceding disclosure, and at least a portion of a surface of the packaging unit can be transparent or translucent. In some such embodiments, the packaging unit can additionally comprise a second compressible pipette having a fluid-loading tube extending therefrom and being loadable therethrough by negative pressure produced by decompression of the compressible pipette, wherein in a second assembled state, at least a distal tip of the fluid-loading tube of the second compressible pipette can be disposed within the inlet of the dentrifice-delivery lumen so as to (i) form a liquid-tight seal therebetween and/or (ii) complete a dentrifice-flowpath from the compressible pipette to the outlet of the dentrifice-delivery lumen.

A daily oral care kit is disclosed for institutional use with a single oral-care receiver, the kit comprising (a) a hanger; and (b) three packaging units configured to hang below the hanger, each packaging unit comprising: (i) a compressible pipette having a fluid-loading tube extending therefrom and loadable therethrough by negative pressure produced by decompression of the compressible pipette; (ii) a suction toothbrush having a suction-lumen outlet at a proximal end, the toothbrush comprising a dentrifice-delivery lumen having an outlet within a distally-disposed field of toothbrush bristles and an inlet displaced proximally therefrom; and (iii) an attachment element arranged on an external surface of the suction toothbrush, displaced proximally from the dentrifice-delivery-lumen inlet, the attachment configured to receive the compressible pipette, and in an assembled state, retain the compressible pipette in a fixed orientation and in a fixed position displaced outward from the external surface of the suction toothbrush.

In some embodiments, each packaging unit can additionally comprise a second compressible pipette having a fluid-loading tube extending therefrom and loadable therethrough by negative pressure produced by decompression of the compressible pipette.

In some embodiments, each packaging unit can additionally comprise a bendable suction member.

A method is disclosed, according to embodiments, for providing oral care to an oral-care receiver by using an oral care kit comprising (i) a suction toothbrush comprising a suction lumen and a dentrifice-delivery lumen, (ii) a compressible pipette having a fluid-loading tube extending therefrom and being loadable therethrough, and (iii) an attachment element arranged on an external surface of the suction toothbrush and configured to receive the pipette. The method comprises: (a) loading a quantity of a dentrifice into the pipette; (b) mating (e.g. by penetration where a distal end of the fluid-loading tube penetrates into the dentrifice-delivery lumen at a proximal end thereof) (e.g. an “external mating”—at a location outside of main body of the toothbrush) the fluid-loading tube with an inlet of the delivery lumen so as to create a dentrifice-flowpath from the pipette to an outlet of the delivery lumen disposed within or in proximity to a distally-disposed field of toothbrush bristles; (c) (e.g. subsequent to the mating) joining and/or docking the suction toothbrush and the pipette using the attachment element; and (d) expelling at least a portion of the quantity of the dentrifice from the pipette by directly applying a compressive force (e.g. in a lateral direction) on an exposed deformable portion of an outer surface of the pipette, so that at least some of said portion exits the pipette, traverses the delivery lumen and exits via the outlet of the delivery lumen, said at least some of said portion being effective to provide oral care when applied to the teeth of the oral-care receiver.

In some embodiments, the method is performed so that the docking causes bending of the fluid-loading tube—for example, by at least 10 degrees or at least 20 degrees or at least 30 degrees). For example, because at distal end of the fluid loading tube may penetrate (e.g. by at least 1 mm) into the dentrifice-delivery lumen at a proximal end thereof, a contact force between an outer surface of the dentrifice and an inner surface of the dentrifice-delivery lumen may hold a tip of the fluid-loading tube in place so that subsequent attaching and/or docking fluid storage compartment to the attachment element causes bending of the fluid-loading tube)

In some embodiments, the compressible pipette can be laterally compressible. In some embodiments, the compressible pipette can include a bellows portion at a proximal end and is longitudinally compressible.

In some embodiments, it can be that the inlet of the dentrifice-delivery lumen faces proximally, and/or, in the assembled state, the outlet pipe of the pipette is distally oriented.

In some embodiments, it can be that (i) the attachment element comprises a snap-in cradle, and/or (ii) the joining comprises snapping the pipette into the snap-in cradle.

In some embodiments, it can be that (i) the attachment element comprises a ring or a ring segment and/or (ii) the joining includes inserting the pipette into the ring or ring segment.

In some embodiments, the mating can be performed before the joining. In some embodiments, the mating can be performed after the joining.

According to embodiments, an oral care kit comprises: (a) a compressible pipette comprising (i) a fluid-storage compartment having a quantity of a dentrifice disposed within, and (ii) a fluid-loading tube extending from the fluid-storage compartment and sealed by a detachable tab at its distal end, the tab being hand-detachable from said fluid-loading tube without tools by breaking off and/or tearing off the tab, the tab being effective, prior to detaching, to provide a liquid-tight seal covering an only external aperture of the compressible pipette, wherein, with the tab removed, a wall of the fluid-storage compartment is deformable so that when a compressive force is applied to the wall, the fluid-storage compartment is at least partly compressed; and (b) a suction toothbrush having an attachment element that is (i) externally disposed on a lateral-facing surface of the suction toothbrush; and (ii) configured to stably and detachably retain the compressible pipette in a fixed orientation external to the suction toothbrush, the suction toothbrush comprising (i) a suction-lumen outlet at a proximal end, and (ii) a dentrifice-delivery lumen having an dentrifice-delivery outlet within or in proximity to a distally-disposed field of toothbrush bristles, and an inlet displaced proximally therefrom; wherein when the compressible pipette is stably retained by the attachment element in the fixed orientation external to the suction toothbrush with the tab removed, at least two of three of the conditions outlined in (i), (ii), and (iii) are met: (i) at least one external surface of the fluid-storage compartment is exposed and accessible to direct access; (ii) a distal end of the fluid-loading tube forms a fluid-tight seal with a proximal end of the dentrifice-delivery lumen to complete a dentrifice flowpath from an interior of the fluid-storage compartment through the only external aperture of the compressible pipette to the dentrifice-delivery outlet; and (iii) a compressive force directly applied upon the exposed and directly accessible external surface of the deformable wall of the fluid-storage compartment at least partially compresses the fluid-storage compartment to expel therefrom at least part of the quantity dentrifice stored therein so that the expelled dentrifice follows the dentrifice flowpath and exits the dentrifice-delivery lumen via the dentrifice-delivery outlet.

In some embodiments, the fluid-storage compartment can have only a single aperture, at a proximal end of the fluid-loading tube. In some embodiments, the compressible pipette can have only a single aperture, at a distal end of the fluid-loading tube.

In some embodiments, a hardness of the fluid-loading tube exceeds a hardness of walls of the fluid delivery compartment.

In some embodiments, it can be that no valve is disposed in the dentrifice flowpath.

In some embodiments, a length of the fluid-loading tube can bes at least 30% of a longest dimension of the fluid-storage compartment.

In some embodiments, it can be that: (i) the fluid-storage compartment is elongated to define an elongate axis, (ii) when the pipette is detached from the suction toothbrush, the fluid-loading tube is aligned with the elongate axis of the fluid-storage compartment, and (iii) when the compressible pipette is stably retained by the attachment element in the fixed orientation external to the suction toothbrush, the fluid-loading tube is laterally bent toward an external surface of the suction toothbrush to complete the dentrifice flowpath.

In some embodiments, the compressible pipette can be laterally compressible. Additionally or alternatively. the compressible pipette can include a bellows at a proximal end and be longitudinally compressible.

In some embodiments, the oral care kit can additionally comprise a bendable suction member.

In some embodiments, the attachment element can comprise a snap-in cradle. In some embodiments, the attachment element can comprise a ring or a ring segment.

In some embodiments, it can be that the oral care kit has an unassembled state and an assembled state, such that when in the assembled state (i) the detachable tab is removed, (ii) the compressible pipette is stably retained by the attachment element in the fixed orientation external to the suction toothbrush, and (iii) at least a distal tip of the fluid-loading tube of the compressible pipette is disposed within the inlet of the dentrifice-delivery lumen so as to form a liquid-tight seal therebetween and complete a dentrifice-flowpath from the compressible pipette to the outlet of the dentrifice-delivery lumen.

In some embodiments, it can be that the inlet of the dentrifice-delivery lumen faces proximally, and, in the assembled state, the fluid-loading tube of the pipette is distally oriented.

In some embodiments, when in the assembled state, at least a deformable portion of an outer surface of the pipette is uncovered and open to direct external contact.

According to embodiments, a packaging unit can comprise an oral care kit according to any of the foregoing embodiments, wherein at least a portion of a surface of the packaging unit is transparent or translucent. In some embodiments, the packaging unit can additionally comprise a second compressible pipette including (i) a fluid-storage compartment having a quantity of a dentrifice disposed within, and (ii) a fluid-loading tube extending from the fluid-storage compartment and sealed by a detachable tab at its distal end, wherein when in a second assembled state, at least a distal tip of the fluid-loading tube of the second compressible pipette is disposed within the inlet of the dentrifice-delivery lumen so as to (i) form a liquid-tight seal therebetween and (ii) complete a dentrifice-flowpath from the second compressible pipette to the outlet of the dentrifice-delivery lumen. In some embodiments, the respective fluid-storage compartments of the two pipettes can be characterized by having respective quantities of two different dentrifices or dentrifice solutions or suspensions. In some embodiments, the respective fluid-storage compartments of the two pipettes can be characterized by having different respective dentrifice quantities.

According to embodiments, a daily oral care kit for institutional use with a single oral-care receiver comprises: (a) a hanger; and (b) three packaging units configured to hang from and/or below the hanger, each packaging unit comprising: (i) a compressible pipette comprising (A) a fluid-storage compartment having a quantity of a dentrifice disposed within, and (B) a fluid-loading tube extending from the fluid-storage compartment and sealed by a detachable tab at its distal end, the tab being hand-detachable from said fluid-loading tube without tools by breaking off and/or tearing off the tab, the tab being effective, prior to detaching, to provide a liquid-tight seal covering an only external aperture of the compressible pipette; (ii) a suction toothbrush having a suction-lumen outlet at a proximal end, the toothbrush comprising a dentrifice-delivery lumen having an outlet within a distally-disposed field of toothbrush bristles and an inlet displaced proximally therefrom; and (iii) an attachment element arranged on an external surface of the suction toothbrush, displaced proximally from the dentrifice-delivery-lumen inlet, the attachment configured to receive the compressible pipette, and in an assembled state, retain the compressible pipette in a fixed orientation and in a fixed position displaced outward from the external surface of the suction toothbrush.

In some embodiments, each packaging unit can additionally comprise a second compressible pipette comprising (i) a fluid-storage compartment having a quantity of a dentrifice disposed within, and (ii) a fluid-loading tube extending from the fluid-storage compartment and sealed by a detachable tab at its distal end.

In some embodiments, each packaging unit can additionally comprise a bendable suction member.

A method is disclosed, according to embodiments, of providing oral care to an oral-care receiver by using an oral care kit comprising (i) a suction toothbrush comprising a suction lumen and a dentrifice-delivery lumen, (ii) a compressible pipette comprising (A) a fluid-storage compartment having a quantity of a dentrifice disposed within, and (B) a fluid-loading tube extending from the fluid-storage compartment and sealed by a detachable tab at its distal end, and (iii) an attachment element arranged on an external surface of the suction toothbrush and configured to receive the pipette, the method comprising: (a) detaching the tab, the detaching including breaking off and/or tearing off without tools; (b) mating the fluid-loading tube with an inlet of the delivery lumen so as to create a dentrifice-flowpath from the pipette to an outlet of the delivery lumen disposed within or in proximity to a distally-disposed field of toothbrush bristles; (c) joining the suction toothbrush and the pipette using the attachment element; and (d) expelling at least a portion of the quantity of the dentrifice from the pipette by directly applying a compressive force on an exposed deformable portion of an outer surface of the pipette, so that at least some of said portion exits the pipette, traverses the delivery lumen and exits via the outlet of the delivery lumen, said at least some of said portion being effective to provide oral care when applied to the teeth of the oral-care receiver.

In some embodiments of the method, the compressible pipette can be laterally compressible. Additionally or alternatively, the compressible pipette can include a bellows portion at a proximal end and be longitudinally compressible.

In some embodiments of the method, it can be that the inlet of the dentrifice-delivery lumen faces proximally, and the outlet pipe of the pipette is distally oriented when in an assembled state characterized by (i) the detachable being removed, (ii) the compressible pipette being stably retained by the attachment element in the fixed orientation external to the suction toothbrush, and (ii) at least a distal tip of the fluid-loading tube of the compressible pipette being disposed within the inlet of the dentrifice-delivery lumen.

In some embodiments, it can be that (i) the attachment element comprises a snap-in cradle, and (ii) the joining comprises snapping the pipette into the snap-in cradle. In some embodiments, it can be that (i) the attachment element comprises a ring or a ring segment and (ii) the joining includes inserting the pipette into the ring or ring segment.

In some embodiments of the method, the mating can be performed before the joining. In some embodiments of the method, the mating can be performed after the joining.

With respect to any of the packaging units having two pipettes as disclosed herein, any or all of the following embodiments can apply:
The respective fluid-storage compartments of the two pipettes can be characterized by having two different dentrifices or dentrifice solutions or suspensions or fluids.
It can be that a first fluid resides in the fluid-storage compartment of a first of the two pipettes, and a second fluid resides in the fluid-storage compartment of a second of the two pipettes, and/or a ratio between a bactericidal effectiveness of the first fluid and a bactericidal effectiveness of the second fluid can be at least 1.5 or at least 2 or at least 3 or at least 5 or at least 10 or at least 20 or at least 50 or at least 100.
The respective fluid-storage compartments of the two pipettes can be characterized by having different respective dentrifice quantities.
A ratio between (i) a quantity of fluid disposed in a fluid-storage compartment of a first of the pipettes and (ii) a quantity of fluid disposed in a fluid-storage compartment of a second of the pipettes can be at least 1.1 or at least 1.25 or at least 1.5 or at least 2 or at least 3.

An article of manufacture can comprise at least N packaging units of any of the packaging units disclosed herein, the packaging units being connected to each other, a value of N being at least 3.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. Also, in some drawings the relative sizes of objects, and the relative distances between objects, may be exaggeratedly large or small for the sake of convenience and clarity of presentation. In the drawings:

FIG. 1A is a schematic side-rear perspective view of a suction toothbrush having a snap-in cradle type pipette-attachment element according to embodiments of the present invention.

FIG. 1B is a top-view detail of the field of toothbrush bristles of the suction toothbrush of FIG. 1A.

FIG. 1C is a schematic side-rear perspective view of a suction toothbrush having a ring-type pipette-attachment element according to embodiments of the present invention.

FIG. 1D is a schematic side-rear perspective view of a suction toothbrush having a ring-segment type pipette-attachment element according to embodiments of the present invention.

FIG. 2A is a schematic drawing showing a laterally compressible pipette and forces acting upon the pipette, according to embodiments of the present invention.

FIG. 2B is a schematic drawing showing a longitudinally compressible bellows-type pipette and forces acting upon the pipette, according to embodiments of the present invention.

FIG. 2C is a schematic drawing showing a laterally compressible pipette having an aperture sealed by a detachable tab, according to embodiments of the present invention.

FIG. 2D is a schematic drawing showing a longitudinally compressible bellows-type pipette having an aperture sealed by a detachable tab, according to embodiments of the present invention.

FIG. 3A is a schematic drawing showing the loading of a pipette with a dentrifice, according to embodiments of the present invention.

FIG. 3B shows the pipette of 3A after loading with the dentrifice.

FIG. 3C schematically illustrates an exemplary approach to attaching the loaded pipette of FIG. 3B to a suction toothbrush, according to embodiments of the present invention.

FIG. 3D shows the pipette and suction toothbrush for FIG. 3C, in an assembled state, according to embodiments of the present invention.

FIG. 4A shows the pipette-toothbrush assembly of FIG. 3D with the lateral application of a compressive force, according to embodiments of the present invention.

FIG. 4B shows a schematic cross-section of the pipette-toothbrush assembly of FIG. 4A with a dentrifice-flowpath through a dentrifice-delivery lumen, according to embodiments of the present invention.

FIG. 5A illustrates a packaging unit comprising a suction toothbrush, two compressible pipettes and a bendable suction member, according to embodiments of the present invention.

FIG. 5A illustrates a packaging unit comprising a suction toothbrush, two compressible pipettes each having an aperture sealed by detachable tabs, and a bendable suction member, according to embodiments of the present invention.

FIG. 6 illustrates a daily oral-care kit comprising a hanger element and three packaging units of the type illustrated in FIG. 5, according to embodiments of the present invention.

FIGS. 7, 8, 9 and 10 show flowcharts of methods for providing oral care to an oral-care receiver, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Note: Throughout this disclosure, subscripted reference numbers (e.g., 10₁ or 10_{A}) may be used to designate multiple separate appearances of elements of a single species, whether in a drawing or not; for example: 10₁ is a single appearance (out of a plurality of appearances) of element 10. The same elements can alternatively be referred to without subscript (e.g., 10 and not 10₁) when not referring to a specific one of the multiple separate appearances, i.e., to the species in general.

For convenience, in the context of the description herein, various terms are presented here. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

The term ‘dentrifice’ as used throughout this disclosure and the claims appended thereto means any liquid, suspension or solution that can be effective in providing part of an oral care treatment, including (non exhaustively) water and dilute solutions or suspensions of other dentrifices.

Embodiments of the present invention relate to oral-care kits for institutional and other use, where the work of medical personnel and of caregivers can be made more efficient by providing them with ready access to such oral-care kits. In some embodiments, an oral-care kit includes a suction toothbrush and an attachable pipette for loading a dentrifice into a dentrifice-delivery lumen built into the toothbrush. In some embodiments, the kit can be packaged in a packaging unit for easy storage and access. In some embodiments, a plurality of kits can be provided for ease of administration; for example a daily oral-care kit may include three such packaging units—i.e., one for each labor shift of the day—and an element that facilitates associating the daily kit with a given oral-care receiver, e.g., a hanger.

Embodiments of the present invention relate to an oral care kit comprising:
a. a compressible pipette having a fluid-storage compartment defining a set of equilibrium dimensions, and a fluid-loading tube 210 extending from the fluid-storage compartment 250, a wall of the fluid-storage compartment being deformable so that:
   when an opening of the fluid-loading tube 210 is in contact with a source of a liquid and the fluid-storage compartment is at least partly compressed, at least partial decompression of the fluid-compartment by a restorative force produces a negative pressure which loads liquid into the fluid storage compartment via the fluid-loading tube 210;
b. a suction toothbrush having an attachment element that is (i) externally disposed on a lateral-facing surface of the suction toothbrush; and (ii) configured to stably and detachably retain the compressible pipette in a fixed orientation external to the suction toothbrush, the suction toothbrush comprising (i) a suction-lumen outlet at a proximal end, and (ii) a dentrifice-delivery lumen having an dentrifice-delivery outlet within or in proximity to a distally-disposed field of toothbrush bristles, and an inlet displaced proximally therefrom, wherein:
when the compressible pipette is stably retained by the attachment element in the fixed orientation external to the suction toothbrush:
   i. at least one external surface of the fluid-storage compartment 250 is exposed and accessible to direct access; and/or
   ii. a distal end of the fluid-loading tube 210 (i.e. the same fluid-loading tube 210 via which the liquid is loaded into the fluid-storage compartment by the at least partial decompression) forms a fluid-tight seal with a proximal end of the dentrifice-delivery lumen to complete a dentrifice flowpath from an interior of the fluid-storage compartment to the dentrifice-delivery outlet; and/or
   iii. a force directly applied upon the exposed and directly accessible external surface of the deformable wall of the fluid-storage compartment at least partially compresses the fluid-storage compartment to expel therefrom dentrifice stored therein so that the expelled dentrifice follows the dentrifice flowpath and exits the dentrifice-delivery lumen via the dentrifice-delivery outlet.

The following paragraphs relate to illustrative although non-limiting examples of kit components that can be useful elements in oral-care kits according to the invention.

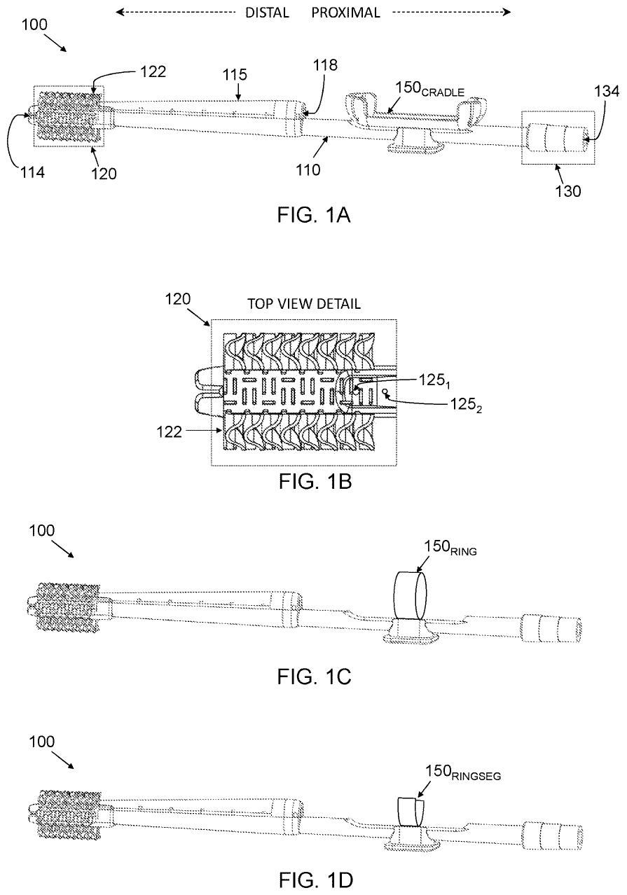

We now refer to FIGS. 1A through 1D. An illustrative example of a suction toothbrush 100 is shown in all four figures. The features common in all four of the FIG. 25 are numbered for reference in FIG. 1A. The suction toothbrush 100 as is known in the art include a suction lumen for extraction of fluids during and after oral-care treatments. In the illustrated example, the suction lumen traverses the entire length of main toothbrush stalk 110, although in other examples a suction inlet port can be elsewhere. As shown in FIG. 1A, a distal suction inlet port 114 is located at the distal end of the toothbrush stalk 110, and a proximal suction 134 outlet is at the proximal end. The relative directions ‘proximal’ and ‘distal’ are illustrated by arrows in FIG. 1A and are relevant for all of the associated figures, FIGS. 1B-1D, and furthermore are used consistently throughout this disclosure. The proximal end of the suction toothbrush 100 is equipped with a suction connector 130 which can be of any standard shape and not necessarily have the three-concenric-ring shape illustrated here. The purpose of the suction connector 130 is for easy and rapid connection to an external suction system and thus whatever connector is appropriate to the suction system can be utilized. The inventors have added a second lumen to the suction toothbrush 100 for the purpose of delivering a dentrifice to the oral cavity of an oral-care receiver from an attachable external container. The dentrifice-delivery lumen 115 is shown here as a mechanically attached ‘add-on’ to the main stalk 110 (the part of the suction toothbrush housing the suction lumen), but obviously in other examples a main stalk can be designed to include a single molded or extruded part housing the two separated lumens. The dentrifice-delivery lumen 115 has an inlet 118 and at least one outlet 125 as shown in FIG. 1B. As will be discussed in greater depth hereinbelow, the dentrifice-delivery lumen 115 serves as part of a dentrifice-flowpath that traverses from a provided source of dentrifice that can be temporarily attached to the suction toothbrush 100 to the at least one outlet 125. The distal end (or a portion near the distal end which may or may not include the actual end/tip) of the suction toothbrush 100 is characterized by a field of toothbrush bristles 120 which includes an array of toothbrush bristles 122. Selecting the size, shape and spacing of the toothbrush bristles is not within the scope of this disclosure, and the skilled artisan will understand that selection of suitable sizes, shapes and spacing of bristles 122 will improve or optimize the efficacy of the oral care provided using the disclosed embodiments. As also shown in FIG. 1B, an outlet 125 of the dentrifice-delivery lumen 115 can be provided within the boundaries of the field of toothbrush bristles 120 (e.g., outlet 1251) or in proximity thereto (i.e., proximate outlet 1252) which means that the outlet 1252 can be within 0.5 cm from the field of toothbrush bristles 120 or within 1.0 cm therefrom or within 1.5 cm therefrom. The object is for the dentrifice to reach the bristles 122 either directly, e.g., through outlet 1251 or near enough to encounter the bristles 122 from outlet 1252 during an oral care treatment. In some embodiments, there is only one outlet 125 which can be either within the field of toothbrush bristles 120 or proximate thereto; in other embodiments there can be multiple outlets 125.

An attachment element 150 is attached, either fixedly or temporarily (i.e., reversibly or detachably) to the suction toothbrush 100 between the proximal inlet 118 of the dentrifice-delivery lumen 115 and the proximal suction port 130. The primary function of the attachment element 150 is to reversibly secure a container, e.g. a pipette that holds a quantity of dentrifice (not shown in FIGS. 1A-1D) and facilitate the mating of the pipette to the proximal inlet 118 of the dentrifice-delivery lumen 115. Any sort of clip, ring or cradle can be utilized as an attachment element 150 in accordance with the size and/or shape of the pipette. In the example of FIG. 1A, the attachment element 150 comprises a snap-in cradle 150_{CRADLE} which can be particularly effective in securing a pipette. In the example of FIG. 1C, the attachment element 150 comprises a ring 150_{RING} with a circumference suitable for retaining a pipette of a ‘matching’ circumference. In the example of FIG. 1D, the attachment element 150 comprises a ring segment 150_{RINGSEG} which can also have a snap-in feature.

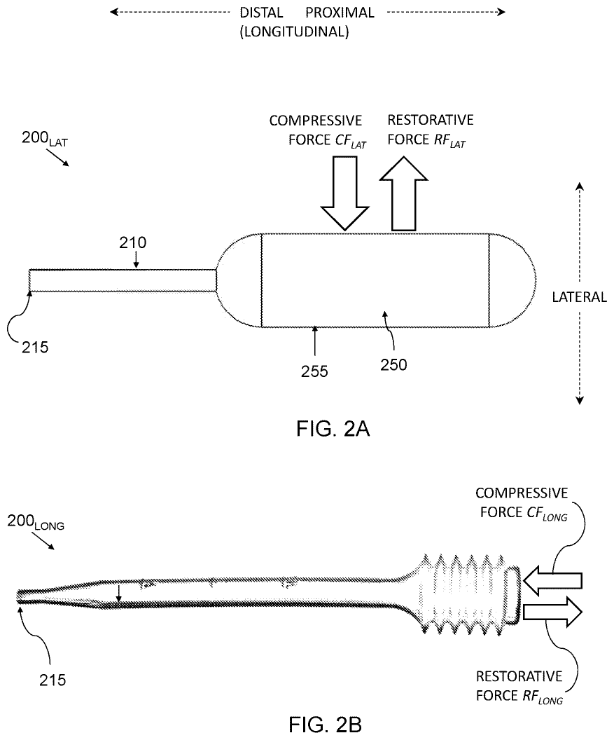

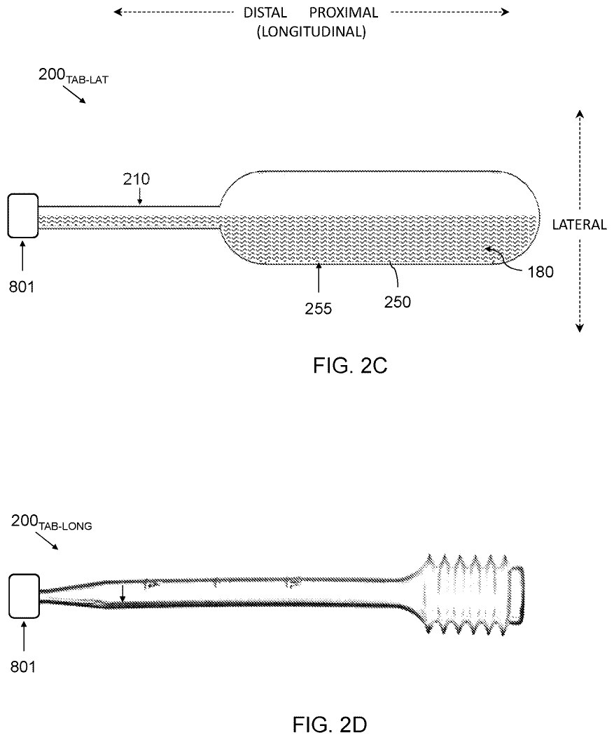

Referring now to FIGS. 2A and 2B, examples of suitable pipettes 200 are shown. Once again, the directional meaning of ‘proximal’ and ‘distal’ are illustrated by the arrows at the top of FIG. 2A, and said meanings apply to both FIGS. 2A and 2B. FIG. 2A illustrates a ‘laterally compressible’ pipette 200_{LAT} where ‘laterally compressible’ means that a wall 255 (which can include a ‘surrounding’ e.g., cylindrical wall) is deformable by application of a laterally-applied compressive force CF_{LAT} (represented by the thus-indicated arrow) which compresses a compartment 250 of the pipette 200_{LAT}. The compression causes a pressure, i.e., a ‘positive’ pressure, meaning an increase of pressure above atmospheric pressure, within the compartment 250. If the pipette is empty of liquids, only air is expelled through loading tube 210 via its outlet/aperture at distal tip 215. Loading tube 210 is designed to mate with the proximal inlet 118 of the dentrifice-delivery lumen 115 (of FIGS. 1A, 1C and 1D) by the insertion of at least the distal tip 215 of the loading tube 210 in the dentrifice-delivery lumen inlet 118. After the compressive force CF_{LAT} is removed, a restorative force RF_{LAT} of equal magnitude and opposite direction biases the wall 255 back to allow the compartment 250 to ‘decompress’ and expand to the original equilibrium shape. The decompression means that a negative pressure is created within the pipette 200. As will be discussed in connection with FIG. 3A, the negative pressure can be effective to ‘load’ the pipette by suctioning in a liquid such as a dentrifice.

What is called herein a ‘loading tube’, i.e., loading tube 210, is a thin (i.e., thinner than the maximum thickness of the pipette, for example between 5% and 90% of the thickness of the pipette) tube or pipe extending from the main body or compartment of a pipette, and in embodiments the outlet of the loading tube 210 can be the only aperture of the pipette—in other words, the loading tube 210 can act as a loading/unloading tube depending on whether it is being compressed (unloading/expelling a fluid through the outlet/aperture at distal tip 215) or decompressed (suctioning in a fluid through the outlet/aperture at distal tip 215).

FIG. 2B illustrates a second example of a compressible pipette. Pipette 200_{LONG} is longitudinally compressible, which means that respective compressive force CF_{LONG} and restorative force RF_{LONG} are applied longitudinally at an end rather than laterally at a side. The example illustrated is of a ‘bellows’ (or ‘accordion’) pipette, where the proximal wall absorbing the compressive force CF_{LONG} is replaced by a bellows that controls deformation of the proximal wall. It will be obvious that a longitudinally applied compressive force on a small surface will require greater deformation than a laterally applied compressive force of the same magnitude, and thus the bellows design serves to control the extent of deformation and ensure that the restorative force biases the pipette back to its equilibrium volume, which might not be possible in the absence of a bellow because of potential damage from extensive deformation.

FIGS. 2C and 2D are schematic illustrations of compressible pipettes 200_{TAB-LAT} and 200_{TAB-LONG}, which are, respectively, identical to compressible pipettes 200_{LAT} and 200_{LONG} illustrated in FIGS. 2A and 2B, except that each of the pipettes in FIGS. 2C and 2D are prefilled with a dentrifice 180 (or, equivalently, a dentrifice-containing solution or suspension) and sealed by detachable tab 801. (Dentrifice 180 is not shown in FIG. 2D.) The detachable tabs are preferably hand-detachable, i.e., so that a caregiver can easily break off or tear off the tab without using any tools.

The meaning of ‘lateral’ and ‘longitudinal’ in FIGS. 2A-D are as indicated by the respectively marked axes shown in the figures.

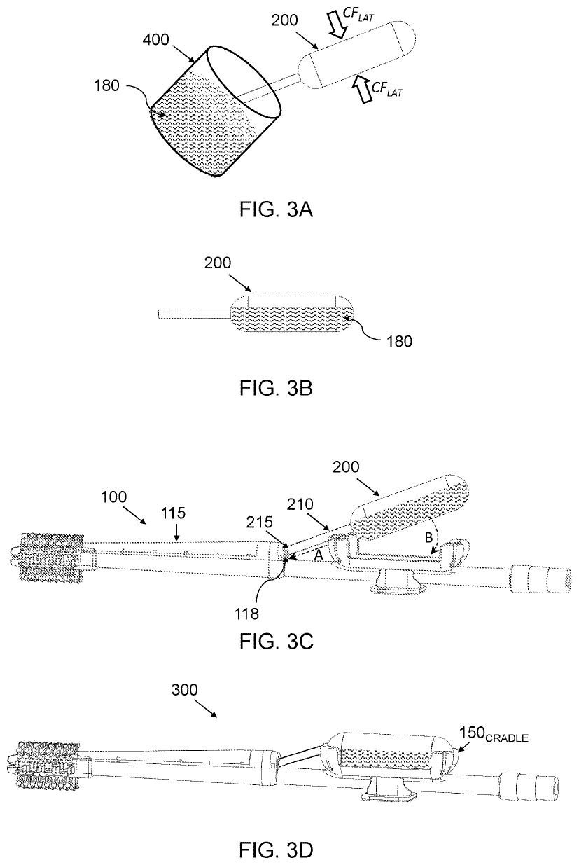

FIGS. 3A-3D illustrate a method of preparing an oral care assembly for use in an oral care treatment. In FIG. 3A, a compressible pipette 200 is ‘loaded’ with a quantity of dentrifice 180 from a container 400. As discussed hereinabove, applying a compressive force to the pipette 200, e.g., squeezing it and inwardly deforming the wall/walls 255 causes a fluid, e.g., the dentrifice 180, to be suctioned through the loading tube 210 and into the main compartment 250 of the pipette 200. The result of the ‘loading’ is shown in FIG. 3B, which illustrates a quantity of dentrifice 180 being loaded within the pipette 200. Alternatively, the pipette 200 of FIG. 3B can be a prefilled pipette of FIG. 2C with detachable tab removed; this is true for any of the pipettes 200 shown in FIGS. 3C, 3D, 4A and 4B.

FIG. 3C schematically illustrates the attachment of the pipette 200 to a suction toothbrush 100. Two steps are indicated by arrows: Arrow ‘A’ indicates the mating of the distal outlet tip 215 of the pipette 200 with the proximal inlet 118 of the dentrifice-delivery lumen 115. Arrow ‘B’ indicates the joining of the pipette 200 with the suction toothbrush 100 using attachment element 150. In the illustrated example of FIG. 3C (and subsequently in FIGS. 3D, 4A, 4B and 5, the attachment element 150 comprises the snap-in cradle 150_{CRADLE} but this is merely for convenience and any suitable attachment element 150 can be employed, including, for example, those attachment elements 150 illustrated in FIGS. 1C and 1D. In some embodiments, the mating (Arrow ‘A’) can take place before the joining (Arrow ‘B’) and in other embodiments can take place after—the underlying concept is to ensure that (i) the main body of the pipette 200 (e.g., the compartment 250) is securely seated and properly oriented, (ii) the loading tube 210 is arranged at the proper angle for mating with the dentrifice-delivery lumen inlet 118 and (iii) the distal outlet 215 of the loading tube 210 is mated with the dentrifice-delivery lumen inlet 118 to form a watertight seal and provide a dentrifice flowpath from the compartment 250 to a dentrifice-delivery lumen outlet 125.

FIG. 3D shows the result of the mating and joining described in the preceding paragraph to create the suction toothbrush-pipette assembly 300, i.e., an oral-care kit in an assembled state.

FIGS. 4A and 4B illustrate the operation of the oral-care kit/assembly 300. FIG. 4B is a schematic cross-sectional view of the assembled-state oral-care kit 300 showing the dentrifice-flowpath through loading tube 210 and dentrifice-delivery lumen 115. A compressive force CF_{LAT} is applied to the deformable external surface/wall 255 of the compartment 250 of the pipette 200, and dentrifice 180 is expelled—by the positive pressure in the compartment 250 due to the compression—and flows from the compartment 250 to an outlet 125 of dentrifice-delivery lumen 115. ‘Drops’ 182 of dentrifice 180 are shown exiting the outlet 125. It can be seen in FIG. 4B that the dentrifice flowpath is an unimpeded channel and includes no valves or other barriers.

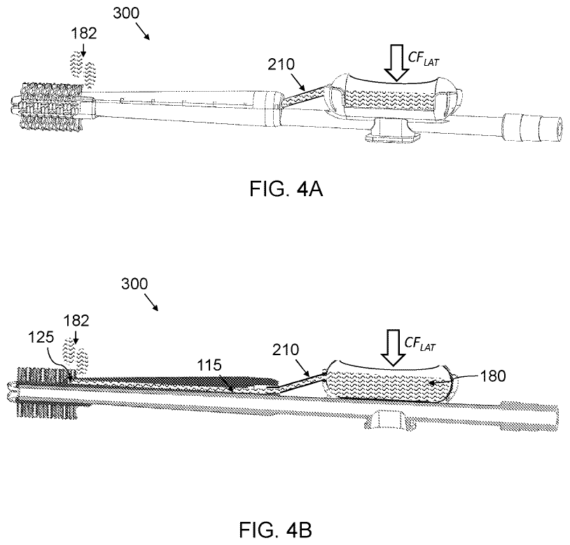

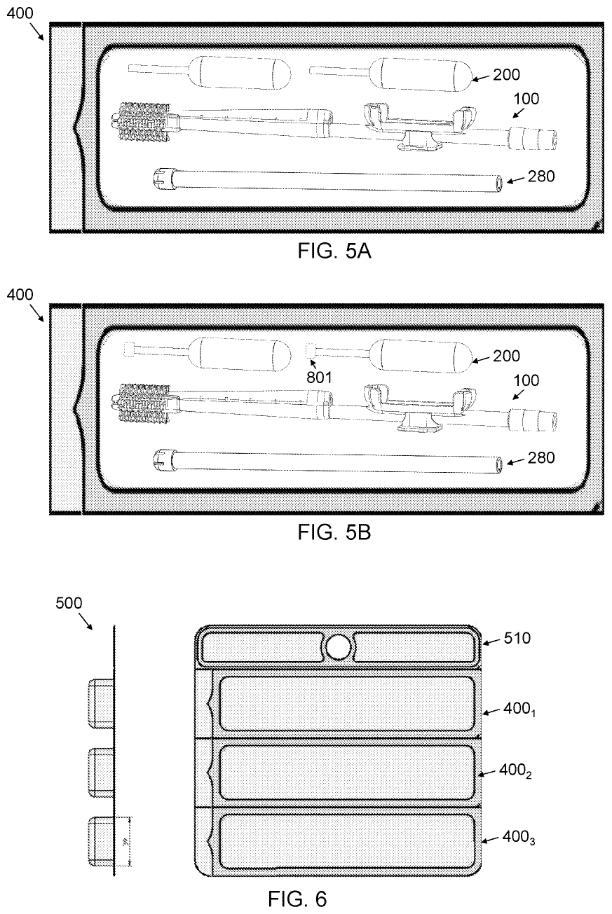

We now refer to FIGS. 5A, 5B and 6. It can be desirable to provide oral care kits that comprise some or all of the kit components described herein according to the disclosed embodiments, within a standard packaging unit for institutional and other use. A non-limiting example of a ‘blister’ package type of packaging unit is shown, but the packaging unit can take on any design and use any suitable material. In some embodiments, it can be advantageous for at least a portion of an external surface of the packaging unit to be transparent, or at least translucent, so that the contents can be quickly discerned from without.

Two non-limiting examples of packaging units 400 are shown in FIGS. 5A and 5B, where each packaging unit comprises a suction toothbrush 100 equipped with a snap-in cradle-type attachment element 150_{CRADLE}, first and second compressible pipettes 200, and a bendable suction member 280 suitable for providing additional or alternate oral-cavity suction capability before, during or after an oral care treatment. A second compressible pipette 200 can be useful, for example for loading a quantity of a second dentrifice 180 into the dentrifice-delivery lumen 115 of the suction toothbrush 100, or for loading a second quantity of the same dentrifice 180. In some other examples (not shown), only one pipette 200 is provided. In some other examples, the bendable suction member 280 is not provided. FIG. 5A illustrates a packaging unit 400 with open and empty pipettes 200, while FIG. 5B shows a packaging unit 400 with prefilled pipettes 200 sealed with respective detachable tabs 801. In some embodiments both prefilled pipettes 200 of FIG. 5B are prefilled with the same dentrifice 180 and in other embodiments the two pipettes 200 contain different dentrifices or different dentrifice solutions or suspensions. In some embodiments, the quantity of dentrifice in each pipette can be different, regardless of whether they are the same dentrifice or two different ones.

In some institutional settings it can be desirable to further provide a super-assembly of oral-care kits for a daily cycle of oral care. For example, there are typically three labor shifts per 24-hour period, and it is common for a care-receiver to receive oral care one time per labor shift. Thus, the use of a daily oral-care kit such as illustrated in FIG. 6 can be advantageous. In the non-limiting example of FIG. 6, a daily oral care kit 500 comprises three packaging units 400₁, 400₂ and 400₃, and a hanging element such as a hanger 510 which can allow the daily oral care kit 500 to be placed in proximity to a care-receiver and left there for the duration of a 24-hour period.

Methods of Providing Oral Care

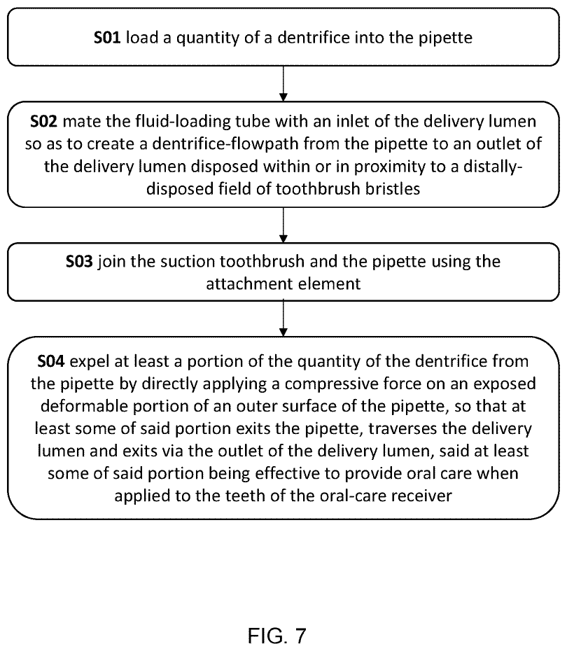

A first method of providing oral care to an oral-care receiver by using an oral care kit 300 is now disclosed, and a flowchart of the method is shown in FIG. 7. According to the method, the oral care kit 300 comprises a suction toothbrush 100 comprising a suction lumen and a dentrifice-delivery lumen 115, a compressible pipette 200 having a fluid-loading tube 210 extending therefrom and being loadable therethrough, and an attachment element 150 arranged on an external surface of the suction toothbrush 100 and configured to receive the pipette 200. The method comprises:
Step S01 loading a quantity of a dentrifice into the pipette;
Step S02 mating the fluid-loading tube with an inlet of the delivery lumen so as to create a dentrifice-flowpath from the pipette to an outlet of the delivery lumen disposed within or in proximity to a distally-disposed field of toothbrush bristles;
Step S03 joining the suction toothbrush and the pipette using the attachment element;
Step S04 expelling at least a portion of the quantity of the dentrifice from the pipette by directly applying a compressive force on an exposed deformable portion of an outer surface of the pipette, so that at least some of said portion exits the pipette, traverses the delivery lumen and exits via the outlet of the delivery lumen, said at least some of said portion being effective to provide oral care when applied to the teeth of the oral-care receiver.

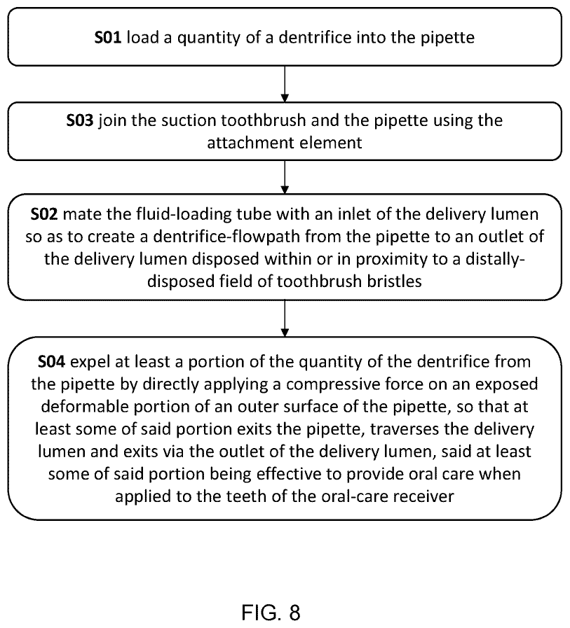

A second method of providing oral care to an oral-care receiver by using an oral care kit 300 is now disclosed, and a flowchart of the method is shown in FIG. 8. According to the second method, the oral care kit 300 comprises a suction toothbrush 100 comprising a suction lumen and a dentrifice-delivery lumen 115, a compressible pipette 200 having a fluid-loading tube 210 extending therefrom and being loadable therethrough, and an attachment element 150 arranged on an external surface of the suction toothbrush 100 and configured to receive the pipette 200. The second method comprises:
Step S01 loading a quantity of a dentrifice into the pipette;
Step S03 joining the suction toothbrush and the pipette using the attachment element;
Step S02 mating the fluid-loading tube with an inlet of the delivery lumen so as to create a dentrifice-flowpath from the pipette to an outlet of the delivery lumen disposed within or in proximity to a distally-disposed field of toothbrush bristles;
Step S04 expelling at least a portion of the quantity of the dentrifice from the pipette by directly applying a compressive force on an exposed deformable portion of an outer surface of the pipette, so that at least some of said portion exits the pipette, traverses the delivery lumen and exits via the outlet of the delivery lumen, said at least some of said portion being effective to provide oral care when applied to the teeth of the oral-care receiver.

It can be understood from the foregoing that the key difference between the first and second methods is the order in which Steps S02 (joining) and S03 (mating) are performed. The order of the joining and mating can depend upon the design of the attachment element 150, among other factors. As shown in FIG. 3C, when the pipette 200 and suction toothbrush 100 are separate, i.e., not yet joined, the loading tube 210 is generally or substantially aligned, e.g., substantially parallel, with a longitudinal axis of the pipette 200 and of the compartment 250. As shown in FIG. 3D, when the kit 300 is in an assembled state, i.e., the pipette 200 is stably retained by the attachment element 150 in an orientation determined by the design of the attachment element 150, and the loading tube 210 is ‘bent’ so as to turn downwards towards an external surface of the suction toothbrush 100 and so as to enter the proximal inlet 118 of the dentrifice-delivery lumen 115. In some embodiments, the bending or redirecting of the loading tube 210 can be done manually before the joining (e.g., as in Step S03) of the pipette 200 with the suction toothbrush 100 using the attachment element 150. In some embodiments, the distal tip 215 of the loading tube 210 can be inserted into the dentrifice-delivery lumen inlet 118 without manually bending the loading tube 150, and then the ‘joining’ can cause the bending of the loading tube 150 because the distal tip 215 of the loading tube is immobilized (inside the inlet 118). In any case, the actual order of the specific steps can be decided upon based on the design of the attachment element 150 together with the selection of the pipette 200.

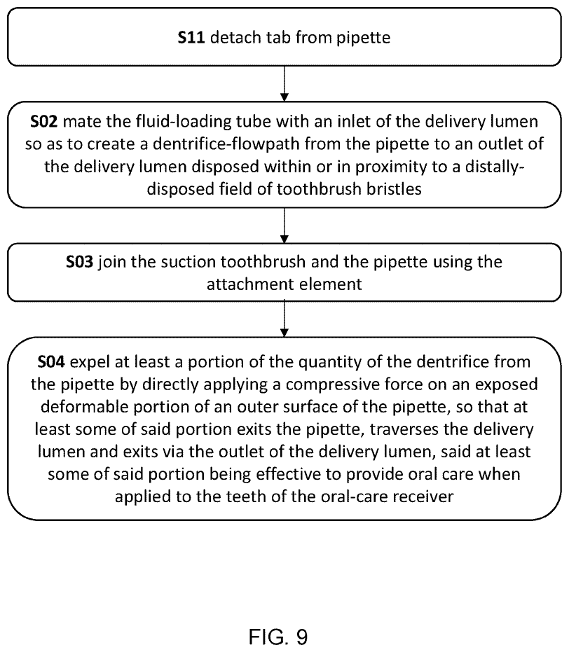

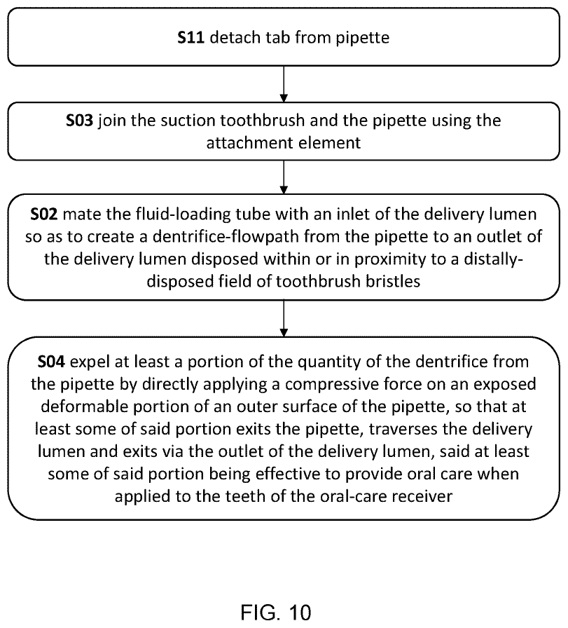

Two additional methods of providing oral care to an oral-care receiver by using an oral care kit 300 are disclosed, and respective flowcharts are shown in FIGS. 9 and 10.

The method illustrated by the flowchart of FIG. 9 is identical to the method illustrated by the flowchart of FIG. 7 except that Step S01 (load a quantity of a dentrifice into the pipette) has been replaced in FIG. 9 by Step S11 (detach tab from pipette). In other words, the method of FIG. 9 is suitably performed when using prefilled pipettes with detachable tabs, e.g., as discussed hereinabove with respect to FIGS. 2C and 2D.

Similarly, the method illustrated by the flowchart of FIG. 10 is identical to the method illustrated by the flowchart of FIG. 8 except that Step S01 (load a quantity of a dentrifice into the pipette) has again been replaced in FIG. 10 by Step S11 (detach tab from pipette). In other words, the method of FIG. 10 is suitably performed when using prefilled pipettes with detachable tabs, e.g., as discussed hereinabove with respect to FIGS. 2C and 2D.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

In the description and claims of the present disclosure, each of the verbs, “comprise”, “include” and “have”, and conjugates thereof, are used to indicate that the object or objects of the verb are not necessarily a complete listing of members, components, elements or parts of the subject or subjects of the verb. As used herein, the singular form “a”, “an” and “the” include plural references unless the context clearly dictates otherwise. For example, the term “a marking” or “at least one marking” may include a plurality of markings.

1. An oral care kit comprising:
a. a compressible pipette including a fluid-storage compartment and a fluid loading tube; and
b. a suction toothbrush comprising (i) a suction-lumen outlet at a proximal end, and (ii) a dentrifice-delivery lumen having an dentrifice-delivery outlet within or in proximity to a distally-disposed field of toothbrush bristles, and an inlet displaced proximally therefrom.

2. The oral care kit of claim 1, wherein (i) the fluid-storage compartment defines a set of equilibrium dimensions, and (ii) the fluid-loading tube extends from the fluid-storage compartment.

3. The oral care kit of claim 1, wherein a wall of the fluid-storage compartment is deformable so that when an opening of the fluid-loading tube is in contact with a source of a liquid and the fluid-storage compartment is at least partly compressed, at least partial decompression of the fluid-compartment by a restorative force produces a negative pressure which loads liquid into the fluid storage compartment via the fluid-loading tube.

4. The oral care kit of claim 1, additionally comprising an attachment element externally disposed on a lateral-facing surface of the suction toothbrush, the attachment element configured to stably and detachably retain the compressible pipette in a fixed orientation external to the suction toothbrush such that at least one external surface of the fluid-storage compartment is exposed and accessible to direct access.

5. The oral kit of claim 4, wherein when the compressible pipette is stably retained by the attachment element in the fixed orientation external to the suction toothbrush, a distal end of the fluid-loading tube forms a fluid-tight seal with a proximal end of the dentrifice-delivery lumen to complete a dentrifice flowpath from an interior of the fluid-storage compartment to the dentrifice-delivery outlet, and (iii) a force directly applied upon the exposed and directly accessible external surface of the deformable wall of the fluid-storage compartment at least partially compresses the fluid-storage compartment to expel therefrom dentrifice stored therein so that the expelled dentrifice follows the dentrifice flowpath and exits the dentrifice-delivery lumen via the dentrifice-delivery outlet.

6. The oral care kit of claim 5, wherein the fluid-storage compartment has only a single aperture, at a proximal end of the fluid-loading tube.

7. The oral care kit of claim 6, wherein the compressible pipette has only a single aperture, at a distal end of the fluid-loading tube.

8. The oral care kit of claim 1, wherein a hardness of the fluid-loading tube exceeds a hardness of walls of the fluid delivery compartment.

9. The oral care kit of claim 1, wherein no valve is disposed in the dentrifice flowpath.

10. The oral care kit of claim 1, wherein:
i. the fluid-storage compartment is elongated to define an elongate axis,
ii. when the pipette is detached from the suction toothbrush, the fluid loading tube is aligned with the elongate axis of the fluid-storage compartment, and
iii. when the compressible pipette is stably retained by the attachment element in the fixed orientation external to the suction toothbrush, the fluid-loading tube is laterally bent toward an external surface of the suction toothbrush to complete the dentrifice flowpath.

11. The oral care kit of claim 1, wherein the compressible pipette is laterally compressible.

12. The oral care kit of claim 1, wherein the compressible pipette includes a bellows at a proximal end and is longitudinally compressible.

13. The oral care kit of claim 1, additionally comprising a bendable suction member.

14. The oral care kit of claim 1, wherein the attachment element comprises a snap-in cradle.

15. The oral care kit of claim 1, wherein the attachment element comprises a ring or a ring segment.

16-48. (canceled)
